(19) United States
(12) Patent Application Publication
(10) Pub. No.: US 2026/0341033 A1
(43) Pub. Date: Oct. 29, 2026

(54) Method For Detecting An Ego-Shadow Of A Motor Vehicle, Driver Assistance System For A Motor Vehicle, And Motor Vehicle

(71) Applicant: Volkswagen Aktiengesellschaft, Wolfsburg (DE)

(72) Inventors: Carolin Last, Wolfsburg (DE); Philipp Hüger, Wolfsburg (DE); Bastian Góricke, Wolfsburg (DE); Robert Beer, Wolfsburg (DE)

(73) Assignee: Volkswagen Aktiengesellschaft, Wolfsburg (DE)

(21) Appl. No.: 19/648,534

(22) Filed: Apr. 15, 2026

(30) Foreign Application Priority Data
Apr. 29, 2025 (DE) 10 2025 116 450.9

(51) Int. Cl. G06V 20/56; G06T 7/13

(52) U.S. Cl. CPC G06V 20/56; G06T 7/13

(57) ABSTRACT

A method for detecting an ego-shadow of a motor vehicle comprises: determining a geographic position and an orientation of the motor vehicle; capturing at least one environmental image by means of at least one camera of a camera arrangement of the motor vehicle; determining a position of the sun relative to the geographic position; determining, whether an ego-shadow of the motor vehicle is to be expected; calculating a predicted ego-shadow of the motor vehicle using the position of the sun, the geographic position and the orientation of the motor vehicle, and information regarding the geometric shape of the motor vehicle; when an ego-shadow is to be expected, determining an ego-shadow candidate in the at least one environmental image by means of the evaluation circuit using the predicted ego-shadow; and verifying that the ego-shadow candidate is the ego-shadow of the motor vehicle by comparing the ego-shadow candidate with the predicted ego-shadow.

### CROSS-REFERENCE TO RELATED APPLICATIONS

This application claims priority to German Patent Application DE 10 2025 116 450.9, filed on Apr. 29, 2025 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The present disclosure relates to a method for detecting an ego-shadow of a motor vehicle, comprising the steps of determining a geographic position and an orientation of the motor vehicle, capturing at least one environmental image by means of a camera of a camera, arrangement of the motor vehicle, determining a position of the sun relative to the geographic position, and calculating, by means of an evaluation circuit, a predicted ego-shadow of the motor vehicle using the position of the sun, the geographic position and the orientation of the motor vehicle, and information regarding the geometric shape of the motor vehicle.

The present disclosure further relates to a driver assistance system for a motor vehicle and to a motor vehicle comprising a driver assistance system.

For many camera-based driver assistance systems, the shadow cast by the motor vehicle presents a problem, since it moves along with the motor vehicle and varies depending on the direction of travel. For example, in the context of a top-view visualization in parking assistance systems, artifacts may occur when the top-view visualization is assembled from multiple camera images. Stitching effects then result in unnatural cast shadows. In general, in functions that use a history of camera images, false detections frequently occur due to the shadow of the motor vehicle itself. Another problem is that, due to its motion, the ego-shadow can be mistaken for a moving object, to which a driver assistance system may erroneously respond, for example by performing emergency braking. This problem arises in particular in the case of bright sunlight and an associated constant, pronounced casting of shadows.

Sources of error in methods for detecting an ego-shadow of a motor vehicle comprise an incorrect determination of the current position of the sun or an obscuration of the sun, for example by clouds or buildings. In such cases, it can occur that the ego-shadow is not correctly detected, or that a shadow that does not originate from the ego vehicle is detected as the ego-shadow.

### SUMMARY

A need exist to provide methods, systems, and motor vehicles for detecting an ego-shadow of a motor vehicle, by means of which the detection of an ego-shadow of a motor vehicle is improved. The need is addressed by the subject matter of the independent claim(s). Embodiments of the invention are described in the dependent claims, the following description, and the drawings.

### BRIEF DESCRIPTION OF THE DRAWINGS

FIG. 1 shows a flowchart of an example method for detecting an ego-shadow of a motor vehicle;

FIG. 2 shows an example motor vehicle;

FIG. 3 shows an example first environmental image;

FIG. 4 shows an example second environmental image;

FIG. 5 shows an example motor vehicle with a clear line of sight to the sun;

FIG. 6 shows an example motor vehicle with an obstructed line of sight to the sun;

FIG. 7 shows an example motor vehicle having an ego-shadow and a predicted ego-shadow; and

FIG. 8 shows an example motor vehicle with an ego-shadow and a predicted ego-shadow with determined line segments.

In some embodiments, a method for detecting an ego-shadow of a motor vehicle comprises:
Determining a geographic position and an orientation of the motor vehicle,
Capturing at least one environmental image by means of at least one camera of a camera arrangement of the motor vehicle,
Determining a position of the sun relative to the geographic position,
Determining, by means of an evaluation circuit, from the at least one environmental image whether an ego-shadow of the motor vehicle is to be expected,
Calculating, by means of the evaluation circuit, a predicted ego-shadow of the motor vehicle using the position of the sun, the geographic position and the orientation of the motor vehicle, and information regarding the geometric shape of the motor vehicle,
Determining an ego-shadow candidate in the at least one environmental image by means of the evaluation circuit using the predicted ego-shadow, when an ego-shadow is to be expected
Verifying that the ego-shadow candidate is the ego-shadow of the motor vehicle by comparing the ego-shadow candidate with the predicted ego-shadow by means of the evaluation circuit.

The ego-shadow may also be referred to as the vehicle's own shadow and designates the shadow in the environment of the motor vehicle that is caused by the motor vehicle as a result of sunlight.

A motor vehicle configured to perform the method comprises a camera arrangement having at least one camera. Such cameras are installed in known motor vehicles for various functions of the vehicle. Accordingly, camera arrangements for assessing traffic situations are known for the functioning of driver assistance systems. Furthermore, modern motor vehicles comprise camera arrangements with cameras for generating top-view representations of the motor vehicle, for example, for parking assistance systems.

According to some embodiments, at least one environmental image is captured by at least one camera of the camera arrangement. However, it is also possible for multiple environmental images to be captured by means of multiple cameras of the camera arrangement.

The evaluation circuit (also referred to as ‘evaluation apparatus’ herein) may comprise one or more electronic computing devices and, in particular, may have a processor, microcontroller, ASIC, CPU and/or a memory. The evaluation circuit may additionally be an evaluation circuit of the motor vehicle and be arranged therein. Furthermore, it is possible for the evaluation circuit to be an external evaluation circuit that can exchange data with a computing unit of the motor vehicle, for example via a wireless connection.

The geometric shape of the motor vehicle is in some embodiments stored in a memory of the evaluation circuit and may be retrieved by the evaluation circuit from the memory for calculating the predicted ego-shadow.

In some embodiments, it is provided that, by means of the evaluation circuit, it is determined from the at least one environmental image whether an ego-shadow of the motor vehicle is to be expected. Situations in which no ego-shadow of the motor vehicle is to be expected can be, for example, heavy cloud cover or obscuration of the sun by buildings, motor vehicles, or infrastructure installations in the surroundings of the motor vehicle.

In some embodiments, it is further provided that the determination of an ego-shadow candidate in the environmental image is performed for example only when an ego-shadow is to be expected. In other words, if no ego-shadow of the motor vehicle is to be expected, no ego-shadow candidate is determined in the environmental image. In this way, false detections in which shadows that do not originate from the motor vehicle are detected as ego-shadows can be avoided. It may further be provided that the step of calculating the predicted ego-shadow is performed only when it has been determined that an ego-shadow of the motor vehicle is to be expected.

For example, in order to determine whether an ego-shadow is to be expected, a lighting comparison may be performed between multiple regions of the at least one environmental image and/or between multiple environmental images.

If the environmental image captured by the at least one camera of the camera arrangement has regions of significantly different lighting, or if the environmental images captured by multiple cameras of the camera arrangement of the motor vehicle have significantly different lighting or have regions of significantly different lighting, that is to say that regions or environmental images are overexposed in comparison with other regions or other environmental images, then it can be concluded that the sun is shining, i.e., that the sun is not obscured by clouds, buildings, or vehicles. This may be evaluated as indicating that an ego-shadow of the motor vehicle is to be expected.

If a lighting comparison between different regions of the at least one environmental image or between the multiple environmental images reveals that the lighting is largely constant, this may indicate that direct sunlight is blocked due to cloud cover or surrounding buildings, and thus no ego-shadow of the motor vehicle is to be expected. In this case, no determination is made as to whether a shadow determined from the environmental image is the ego-shadow of the motor vehicle, so that false detections in which shadows that do not originate from the motor vehicle are detected as ego-shadows can be avoided.

For example and in some embodiments, it is provided that an ego-shadow is to be expected if it is determined from the at least one environmental image that no object is located on a line of sight between the sun and the geographic position of the motor vehicle.

It may likewise be provided that no ego-shadow is to be expected if it is determined from the at least one environmental image that an object is located on a line of sight between the sun and the geographic position of the motor vehicle.

For example, it may in some embodiments be determined from the environmental image by means of an image recognition method whether the sun is detectable in the image section of the environmental image. If the sun is detected in an environmental image, a clear line of sight exists between the sun and the geographic position of the motor vehicle, and thus an ego-shadow of the motor vehicle is to be expected.

If the sun cannot be found in the environmental image or in the multiple environmental images, this may indicate that an object is located on a line of sight between the sun and the geographic position of the motor vehicle. In this case, it can be determined that no ego-shadow is to be expected.

In some embodiments, it may be provided that the object is a cloud, a vehicle, a tree, or a building.

In some embodiments, it may be provided that the position of the sun comprises a height and a horizontal angle.

The horizontal angle is also referred to as the azimuth.

In some embodiments, it may be provided that the height and/or the horizontal angle is determined from the geographic position of the motor vehicle and/or the orientation of the motor vehicle and/or from a date and/or a time.

If the geographic position and/or the orientation of the motor vehicle as well as the date and/or the time are known, the position of the sun, in particular the height and/or the horizontal angle of the sun, at the geographic position of the motor vehicle can be determined by means of known mathematical methods or by evaluating a sun position table in some embodiments.

In some embodiments, it may be provided that the height and/or the horizontal angle is determined from the at least one environmental image.

In general, the height of the sun can be readily determined from the determined geographic position of the motor vehicle and by using the date and the time. However, if the orientation of the motor vehicle exhibits increased uncertainty, the horizontal angle may, under certain circumstances, be determined only with limited accuracy. In this case, it is particularly beneficial in some embodiments if the environmental image is evaluated by means of the evaluation circuit in order to determine the horizontal angle and/or the height of the sun.

If, for example, the sun is detected in the at least one environmental image by means of an image recognition method, then the height and/or the horizontal angle can be determined using knowledge of the position of the camera that captures the environmental image on the motor vehicle. As explained above, it can also be determined in this case that an ego-shadow of the motor vehicle is to be expected.

For example, it is provided that the predicted ego-shadow is a projection of the geometric shape of the motor vehicle onto a plane and/or onto a ground plane.

Thus, the predicted ego-shadow may be calculated by a projection of the geometric shape of the motor vehicle, which is for example stored in a memory of the evaluation circuit of the motor vehicle, onto a plane by means of known mathematical methods. For example, the plane is defined as being substantially parallel to the ground plane on which the motor vehicle is located. In principle, it is also possible for the predicted shadow, given knowledge of the geometry of the ground on which the motor vehicle is located, for example a road plane, to be calculated as a projection onto this ground plane corresponding to the actual conditions. In this way, distortions of the ego-shadow occurring due to the geometric structure of the ground plane can be taken into account.

In some embodiments, it is provided that for example rectilinear first line segments of an edge of the predicted ego-shadow are determined, that, using the first line segments, for example rectilinear second line segments are determined in the environmental image, and that the second line segments are assigned to an edge of the ego-shadow candidate.

Thus, the predicted ego-shadow may be used as an initial approximation for the determination of an ego-shadow candidate. Line segments can be detected in the at least one environmental image by means of an image recognition method. If these line segments have an identical or similar position and/or orientation to the first line segments, then the line segments detected in the environmental image are determined as second line segments of an edge of an ego-shadow candidate. The first line segments for example serve as first approximations in order to restrict the search region for the second line segments. This approach is beneficial because straight or only slightly curved edges of a shadow, that is to say the boundary between a shadow and the surrounding unshaded region, can be detected more easily and more reliably by means of an image recognition method. Furthermore, the computational effort for determining the ego-shadow candidate in the environmental image is reduced.

The first line segments may also be slightly rounded and for example correspond to substantially straight contours of the motor vehicle, such as, for example, the contour of the roof or of the hood.

After determination of the ego-shadow candidate, it may in some embodiments be verified whether the ego-shadow candidate is the ego-shadow of the motor vehicle. To this end, a comparison of the position and/or the orientation of the first line segments of the predicted ego-shadow and of the second line segments of the ego-shadow candidate is performed.

It may also be provided in some embodiments that the second line segments are connected to form a contour. In this way, a complete edge of the ego-shadow candidate can be obtained.

By connecting the second line segments, a continuous edge of the ego-shadow candidate may be approximated. If the ego-shadow candidate is the ego-shadow of the motor vehicle, a more precise matching with the predicted ego-shadows can take place with this approximation of the edge of the ego-shadow candidate.

It may be provided in some embodiments that the second line segments are connected on the basis of a brightness gradient of the at least one environmental image, and/or that the second line segments are connected on the basis of extrapolated intersection points of the second line segments.

The second line segments may also be connected by using methods of artificial intelligence, such as, for example, trained neural networks.

For example, it may be provided that the geographic position of the motor vehicle is determined by means of data of a satellite navigation system, and/or that the geographic orientation of the motor vehicle is determined by means of a rotation rate sensor and/or a compass.

Some further embodiments relate to a driver assistance system for a motor vehicle, configured to perform a method of the teachings herein according to one or more embodiments.

The operation of the driver assistance system of the motor vehicle according to the teachings herein may reduce false detections of the ego-shadow of the motor vehicle.

For example, it may be provided that the driver assistance system is an emergency braking assistance system or an autonomous driving system. For example, the determined ego-shadow may be discarded for an assessment a traffic situation.

If the driver assistance system is an emergency braking assistance system or an autonomous driving system, the risk that the ego-shadow, due to its movement, is mistaken for a moving object is reduced. In this way, critical traffic situations during operation of the driver assistance system may potentially be avoided.

In some embodiments, it may be provided that the driver assistance system provides a representation of the motor vehicle from a bird's-eye view, and that the determined ego-shadow is used for a realistic representation of the ego-shadow in the representation of the motor vehicle.

The representation of the motor vehicle from a bird's-eye view may also be referred to as a top-view representation and is employed in particular for visualization in parking assistance systems in some embodiments. The determined ego-shadow may in particular be used to provide a realistic contour of the determined ego-shadow in the representation of the motor vehicle from the bird's-eye view or to remove the ego-shadow from the representation. Stitching effects that can occur when combining different environmental images can be avoided.

In some embodiments, a motor vehicle is provided, comprising the driver assistance system of the teachings herein.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS.

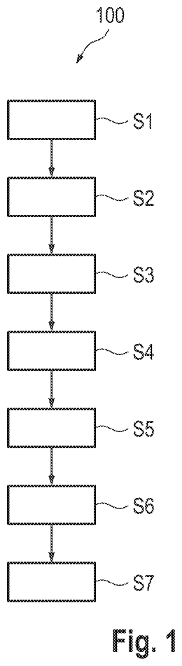

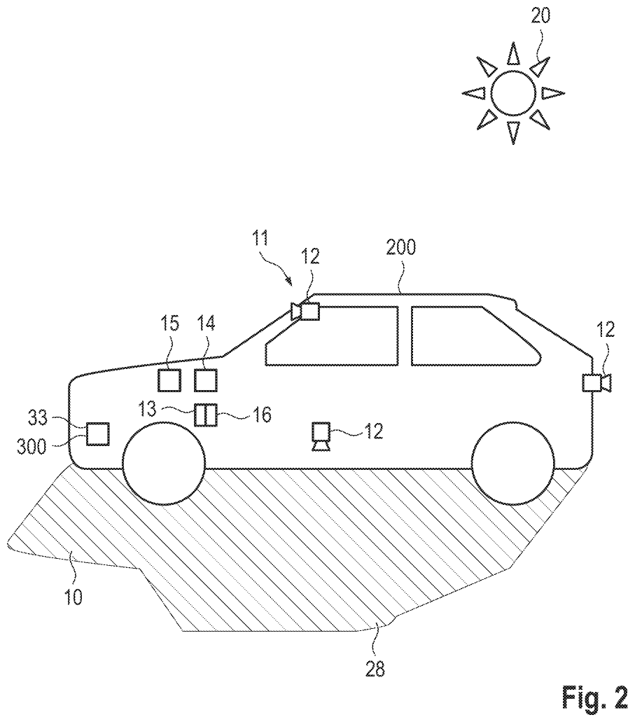

FIG. 1 shows a flowchart of a method 100 for detecting an ego-shadow 10 of a motor vehicle 200. For an explanation of the method 100, further reference is made to FIGS. 2 to 8.

FIG. 2 shows a motor vehicle 200 configured to perform the method 100. The motor vehicle 200 comprises a camera arrangement 11 having multiple cameras 12. Furthermore, the motor vehicle 200 comprises an evaluation circuit 13. Software or else a computer program for performing the method 100 for detecting an ego-shadow 10 is executed on the evaluation circuit 13. The motor vehicle 200 further comprises a receiver 14 for a satellite navigation system and a rotation rate sensor or compass 15. Furthermore, information regarding the geometric shape of the motor vehicle 200 is saved in a memory 16 of the evaluation circuit 13.

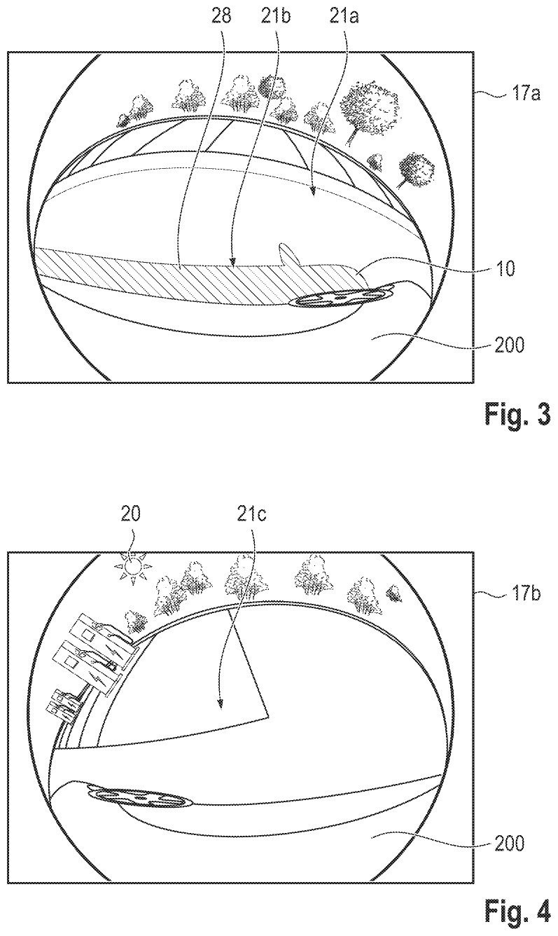

In a first method step S1 according to the flowchart in FIG. 1, a geographic position of the motor vehicle 200 is determined by means of the receiver 14 for a satellite navigation system. Furthermore, the orientation of the motor vehicle 200 is determined on the basis of data from the compass 15 or from the rotation rate sensor. In a second method step S2, environmental images 17a, 17b are captured by means of the cameras 12 of the camera arrangement 11 of the motor vehicle 200. FIGS. 3 and 4 show such environmental images 17a, 17b.

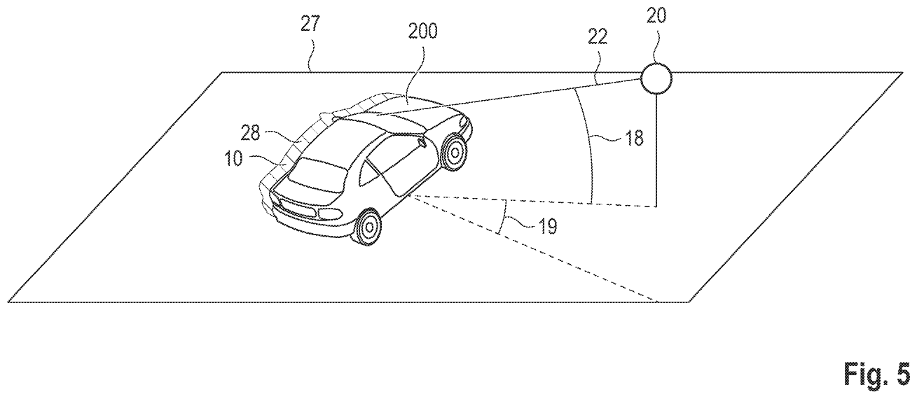

In a third method step S3, a position of the sun relative to the geographic position is determined. According to FIG. 5, the position of the sun comprises a height 18 and a horizontal angle 19, also referred to as the azimuth. For determining the position of the sun, the geographic position determined by means of the receiver 14 for the satellite navigation system, as well as the date and the time, can be used in order to determine, for example from a table or by means of known calculation methods, the position of the sun applicable to the geographic position. Alternatively or additionally, it is also possible to determine the height 18 and the horizontal angle 19 of the position of the sun by means of direct detection of the sun 20 in at least one of the environmental images 17b (FIG. 4). For this purpose, an image recognition method performed on the evaluation circuit 13 can be employed.

In a fourth method step S4, it is determined, by means of an image recognition method performed on the evaluation circuit 13, from the environmental images 17a, 17b whether an ego-shadow 10 of the motor vehicle 200 is to be expected. This can be performed, for example, by means of a comparison of lighting between several regions 21a, 12b, 21c of the environmental images 17a, 17b. If pronounced differences in lighting between the regions 21a, 21b, 21c are detectable, it can be concluded that an ego-shadow 10 of the motor vehicle 200 is to be expected. Alternatively or additionally, it may also be determined that an ego-shadow 10 of the motor vehicle 200 is to be expected if a direct detection of the sun 20 takes place in at least one of the environmental images 17b.

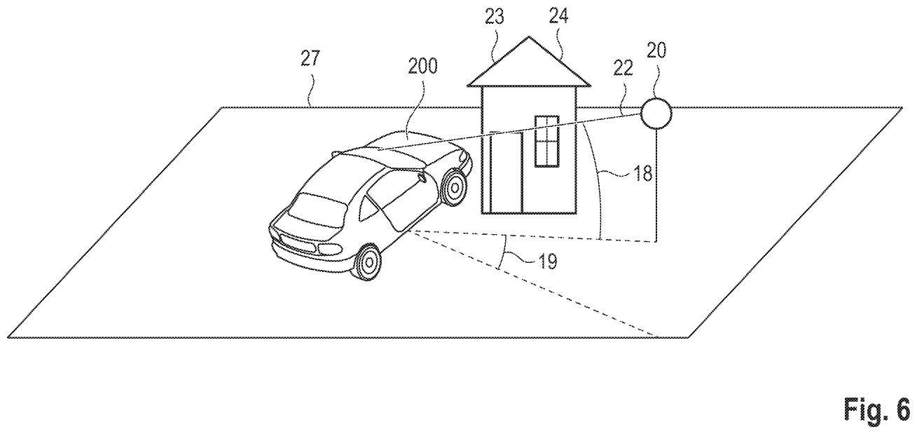

If an ego-shadow 10 of the motor vehicle 200 is to be expected, for example because the sun 20 is detected in one of the environmental images 17b, then, as shown in FIG. 5, a clear line of sight 22 exists between the sun 20 and the motor vehicle 200. If it is determined from the at least one environmental image 17a, 17b that an object 23, such as, for example, a building 24, is located in the line of sight 22 between the sun 20 and the motor vehicle 200, as shown in FIG. 6, then no ego-shadow 10 of the motor vehicle 200 is to be expected.

In a fifth method step S5, a predicted ego-shadow 25 of the motor vehicle 200 is calculated by means of the evaluation circuit 13 using the position of the sun, the geographic position, the orientation of the motor vehicle 200, and information regarding the geometric shape of the motor vehicle 200. For this purpose, known mathematical methods are employed. The predicted ego-shadow 25 is calculated as a projection of the geometric shape of the motor vehicle 200 onto a plane 26 which corresponds to the ground plane 27.

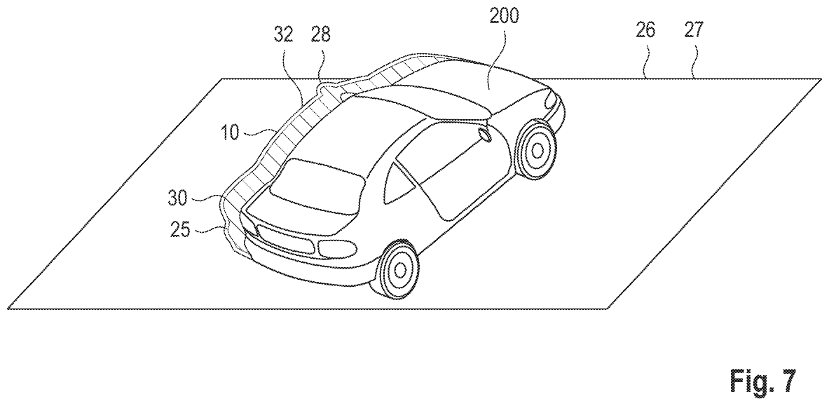

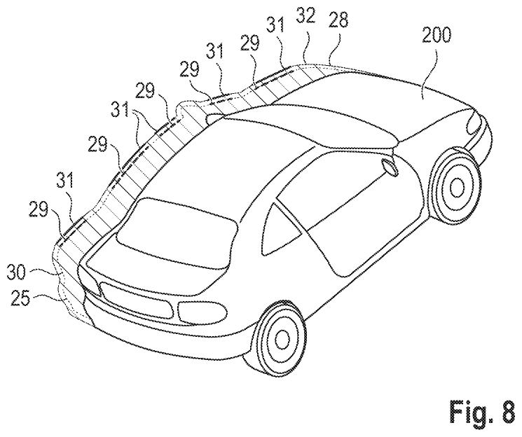

In a sixth method step S6, if an ego-shadow 10 is to be expected, an ego-shadow candidate 28 is determined in the at least one environmental image 17a by means of the evaluation circuit 13 using the predicted ego-shadow 25. For this purpose, as shown in FIGS. 7 and 8, rectilinear first line segments 29 of the edge 30 of the predicted ego-shadow 25 are determined. By means of an image recognition method, line segments are searched for in the at least one environmental image 17a. If these line segments have an identical or similar position and/or orientation to the first line segments 29, then these line segments are determined to be second line segments 31 of an edge 32 of an ego-shadow candidate 28. The first line segments 29 thus serve as first approximations in order to restrict the search region for the second line segments 31.

Then, in a seventh method step S7, a comparison of the position and/or the orientation of the first line segments 29 and the second line segments 31 takes place. If first line segments 29 can be assigned respectively to the second line segments 31, it is determined that the ego-shadow candidate 28 determined from the environmental image 17a is the ego-shadow 10 of the motor vehicle 200.

Returning to FIG. 2, the motor vehicle 200 further comprises a driver assistance system 300, which is configured as an emergency braking assistance system 33 and which processes information regarding the ego-shadow 10 determined by means of the method 100.

### LIST OF REFERENCE NUMERALS

100 Method
200 Motor vehicle
300 Driver assistance system
10 Ego-shadow
11 Camera arrangement
12 Camera
13 Evaluation circuit
14 Receiver
15 Compass
16 Memory
17a Environmental image
17b Environmental image
18 Height
19 Horizontal angle
20 Sun
21a Region
21b Region
21c Region
22 Line of sight
23 Object
24 Building
25 Predicted ego-shadow
26 Plane
27 Ground plane
28 Ego-shadow candidate
29 First line segment
30 Edge
31 Second line segment
32 Edge
33 Emergency braking assistance system
S1-S7 Method steps

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments.
The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1. A method for detecting an ego-shadow of a motor vehicle, comprising:
determining a geographic position and an orientation of the motor vehicle;
capturing at least one environmental image by means of at least one camera of a camera arrangement of the motor vehicle;
determining a position of the sun relative to the geographic position;
determining, by means of an evaluation circuit, from the at least one environmental image whether an ego-shadow of the motor vehicle is to be expected;
calculating, by means of the evaluation circuit, a predicted ego-shadow of the motor vehicle using the position of the sun, the geographic position and the orientation of the motor vehicle, and information regarding the geometric shape of the motor vehicle;
in case an ego-shadow is to be expected, selectively determining an ego-shadow candidate in the at least one environmental image by means of the evaluation circuit using the predicted ego-shadow; and
verifying that the ego-shadow candidate is the ego-shadow of the motor vehicle by comparing the ego-shadow candidate with the predicted ego-shadow by means of the evaluation circuit.

2. The method of claim 1, wherein, in order to determine whether an ego-shadow is to be expected, a lighting comparison is performed between multiple regions of the at least one environmental image and/or between multiple environmental images, and/or wherein an ego-shadow is to be expected if it is determined from the at least one environmental image that no object is located on a line of sight between the sun and the geographic position of the motor vehicle, and/or wherein no ego-shadow is to be expected if it is determined from the at least one environmental image that an object is located on a line of sight between the sun and the geographic position of the motor vehicle.

3. The method of claim 2, wherein the object is a cloud, a vehicle, a tree, and/or a building.

4. The method of claim 1, wherein the position of the sun comprises a height and a horizontal angle, wherein the height and/or the horizontal angle is determined from the geographic position of the motor vehicle and/or the orientation of the motor vehicle and/or from a date and/or a time, and/or wherein the height and/or the horizontal angle is determined from the at least one environmental image.

5. The method of claim 1, wherein the predicted ego-shadow is a projection of the geometric shape of the motor vehicle onto a plane and/or onto a ground plane.

6. The method of claim 1, wherein rectilinear first line segments of an edge of the predicted ego-shadow are determined; wherein, using the first line segments, rectilinear second line segments are determined in the environmental image; and wherein the second line segments are assigned to an edge of the ego-shadow candidate.

7. The method of claim 6, wherein the second line segments are connected to form a contour, wherein the second line segments are connected on the basis of a brightness gradient of the at least one environmental image; and/or wherein the second line segments are connected on the basis of extrapolated intersection points of the second line segments.

8. The method of claim 1, wherein the geographic position of the motor vehicle is determined by means of data from a satellite navigation system; and/or wherein the geographic orientation of the motor vehicle is determined by means of a rotation rate sensor and/or a compass.

9. A driver assistance system for a motor vehicle, configured to:
determine a geographic position and an orientation of the motor vehicle;
capture at least one environmental image by means of at least one camera of a camera arrangement of the motor vehicle;
determine a position of the sun relative to the geographic position;
determine, by means of an evaluation circuit, from the at least one environmental image whether an ego-shadow of the motor vehicle is to be expected;
calculate, by means of the evaluation circuit, a predicted ego-shadow of the motor vehicle using the position of the sun, the geographic position and the orientation of the motor vehicle, and information regarding the geometric shape of the motor vehicle;
in case an ego-shadow is to be expected, selectively determine an ego-shadow candidate in the at least one environmental image by means of the evaluation circuit using the predicted ego-shadow; and
verify that the ego-shadow candidate is the ego-shadow of the motor vehicle by comparing the ego-shadow candidate with the predicted ego-shadow by means of the evaluation circuit.

10. A motor vehicle comprising a driver assistance system according to claim 9.

11. The driver assistance system of claim 9, wherein, in order to determine whether an ego-shadow is to be expected, a lighting comparison is performed between multiple regions of the at least one environmental image and/or between multiple environmental images, and/or wherein an ego-shadow is to be expected if it is determined from the at least one environmental image that no object is located on a line of sight between the sun and the geographic position of the motor vehicle, and/or wherein no ego-shadow is to be expected if it is determined from the at least one environmental image that an object is located on a line of sight between the sun and the geographic position of the motor vehicle.

12. The driver assistance system of claim 11, wherein the object is a cloud, a vehicle, a tree, and/or a building.

13. The driver assistance system of claim 9, wherein the position of the sun comprises a height and a horizontal angle, wherein the height and/or the horizontal angle is determined from the geographic position of the motor vehicle and/or the orientation of the motor vehicle and/or from a date and/or a time, and/or wherein the height and/or the horizontal angle is determined from the at least one environmental image.

14. The driver assistance system of claim 9, wherein the predicted ego-shadow is a projection of the geometric shape of the motor vehicle onto a plane and/or onto a ground plane.

15. The driver assistance system of claim 9, wherein rectilinear first line segments of an edge of the predicted ego-shadow are determined; wherein, using the first line segments, rectilinear second line segments are determined in the environmental image; and wherein the second line segments are assigned to an edge of the ego-shadow candidate.

16. The driver assistance system of claim 15, wherein the second line segments are connected to form a contour, wherein the second line segments are connected on the basis of a brightness gradient of the at least one environmental image; and/or wherein the second line segments are connected on the basis of extrapolated intersection points of the second line segments.

17. The driver assistance system of claim 9, wherein the geographic position of the motor vehicle is determined by means of data from a satellite navigation system; and/or wherein the geographic orientation of the motor vehicle is determined by means of a rotation rate sensor and/or a compass.
